(19) United States
(12) Patent Application Publication
(10) Pub. No.: US 2008/0311239 A1
(43) Pub. Date: Dec. 18, 2008

(54) Apparatus for Blow Molding

(76) Inventor: Paul Alan Miller, Cement City, MI (US)

Correspondence Address: Patent Department;MILACRON INC., 2090 Florence Avenue, Cincinnati, OH, 45206, US

(21) Appl. No.: 11/761,386

(22) Filed: Jun. 12, 2007

(51) Int. Cl. B29C 49/56

(52) U.S. Cl. 425/541

(57) ABSTRACT

An apparatus for blow molding wherein at least one panel insert comprises the molding surfaces of at least one mold component, the depth of at least one panel insert within a recess of the mold component is adjustable in predetermined increments while the panel insert is retained in the recess of the mold component. In one embodiment, relative depth of the panel insert is determined by abutment of stepped seating surfaces comprising at least one indexable post and stepped support surfaces comprising the insert. In a second embodiment, relative depth of the panel insert is determined by abutment of a seating surface comprising at least one indexable rod and a support surface comprising the insert, the seating surface comprising plural longitudinal flats, each flat offset from the rod centerline by different distances, relative depth of the panel insert being determined by abutment of the support surface with a selected flat.

### I. BACKGROUND OF THE INVENTION

1. Field of the Invention

This invention relates generally to blow molding. In particular, this invention relates to molds for producing containers wherein depth of at least one insert is adjustable to permit differing containers to be produced from a single mold assembly.

2. Description of Related Art

Blow molding is a cyclic process wherein a parison of material in a moldable condition is centered on the parting plane of a mold assembly, the mold assembly is closed around the parison, the parison is expanded so the exterior of the parison abuts molding surfaces defined by the closed mold assembly, the blow molded article is conditioned to be sufficiently rigid to retain its size and shape while unsupported, the mold assembly is opened and the blow molded article is removed. In general, the moldable condition of the parison is achieved when the material of the parison is at an elevated temperature, and the rigid condition of the blow molded article is achieved when the temperature of the material has been reduced. A blow molding machine comprises a press for opening and closing the mold assembly, blowing means for introducing a pressurized fluid (typically air) to expand the parison in the mold assembly and means for handling the molded article upon removal from the mold assembly.

Blow molding is commonly used for production of containers wherein the blow molded article comprises a body portion defining a closed end and a neck portion connecting the body and a mouth opening, the mouth opening permitting the container to be filled and to allow the container contents to be dispensed. Mold assemblies for blow molding containers comprise mating mold components wherein molding surfaces open to the mating faces of the mold components define the exterior of the container. Advantageously, the neck portion of the container comprises an exterior surface having a feature, such as a thread, called the “neck finish” for engaging a separable closure and the mating mold components comprise inserts for forming such features. Blow molded containers are known having panels formed in the body portion that can comprise surface decoration, such as product logos, as well as panels designed for the purpose of establishing the volume of the finished container. Such panels are typically formed by replaceable panel inserts of a mold assembly that may be used to produce differing containers.

It is known to provide mold assemblies wherein elevation of replaceable inserts, for example replaceable panel inserts, relative to surrounding molding surfaces can be varied to produce differing containers from a single mold assembly. Known mold assemblies allow the interposition of a shim of predetermined thickness to establish a desired elevation of such inserts. Use of such shims has the disadvantage of requiring partial disassembly of a mold assembly to replace shims, necessitating use of separable fasteners that may become lost or damaged in the course of making a relatively minor alteration to a mold assembly. Advantageously, use of shims permits establishing relative elevation of an insert with precision by predetermined increments according to shim thickness. There is a need for improved mold constructions that permit adjustment of insert elevation or depth can be established in predetermined increments without requiring disassembly involving separation of fasteners from the mold assembly.

### SUMMARY OF THE INVENTION

It is an object of the present invention to provide an apparatus for blow molding wherein at least one panel insert comprises the molding surfaces of at least one mold component, each panel insert being received in a recess of the associated mold component and the depth of at least one panel insert within the associated recess is adjustable in predetermined increments while the panel insert is retained in the recess of the mold component.

It is a further object of the present invention to provide an apparatus for blow molding having at least one panel insert received in a recess of an associated mold component the depth of which is adjustable in predetermined increments while the panel insert is retained in the recess and depth of the panel insert relative to the recess is determined by abutment of stepped seating surfaces comprising at least one indexable post and stepped support surfaces comprising the insert, steps of each of the seating surfaces and support surfaces being brought into abutting contact by retaining means retaining the panel insert in the recess of the mold component.

It is a further object of the present invention to provide an apparatus for blow molding having at least one panel insert received in a recess of an associated mold component the depth of which is adjustable in predetermined increments while the panel insert is retained in the recess and depth of the panel insert relative to the recess is determined by abutment of a seating surface comprising at least one indexable rod and a support surface comprising the insert, abutment of the support surface with a feature of the seating surface establishing a depth of the panel insert different from the depth of the panel insert established by abutting contact with at least one other feature of the seating surface and the apparatus further comprises means for biasing the support surface into abutting contact with the seating surface.

Further objects and advantages of the invention shall be made apparent from the accompanying drawings and the following description thereof.

In accordance with the aforesaid objects an apparatus for blow molding comprises first and second mating mold components, molding surfaces of each mold component being open to the mating face thereof, at least one panel insert comprising the molding surfaces of at least one mold component, each panel insert being received in a recess of the associated mold component and the depth of at least one panel insert within the associated recess being adjustable in predetermined increments while the panel insert is retained in the recess of the mold component. In one embodiment of the invention, the depth of the at least one panel insert of adjustable depth relative to the recess is determined by abutment of stepped seating surfaces comprising an indexable post and stepped support surfaces comprising the insert, steps of each of the seating surfaces and support surfaces being brought into abutting contact by retaining means retaining the panel insert in the recess of the mold component. In a second embodiment of the invention, depth of the panel insert relative to the recess is determined by abutment of a seating surface comprising at least one indexable rod and a support surface comprising the insert, the seating surface of each indexable rod comprising plural flats for determining the depth of the replaceable insert within the recess of the mold component, at least two such flats being spaced from the axial centerline of the rod by differing predetermined offsets, contact of the support surface with one flat of the seating surface establishing a depth of the panel insert different from the depth of the panel insert established by abutting contact with at least one other flat of the seating surface and the apparatus further comprises means for biasing the support surface into abutting contact with the seating surface. A mold assembly comprises mold components in accordance with the invention and a molding machine comprises at least one such mold assembly.

### BRIEF DESCRIPTION OF THE DRAWINGS

FIGS. 1a and 1b illustrate a preformed parison and finished container, respectively, of a two-stage blow molding process.

FIG. 2 is a three dimensional view of a mold assembly comprising a mold component according to the invention.

FIG. 3 is a three dimensional of view of a mold component of FIG. 2.

FIGS. 4a, 4b and 4c are partial cross sectional views of mold components according to the invention taken along line 4-4 of FIG. 3.

FIG. 5 is a three dimensional view of an indexable post of FIG. 4a.

FIG. 6 is a three dimensions view of a replaceable insert of FIG. 4a showing support surfaces thereon.

FIG. 7 is a three dimensional view of an indexable rod of FIGS. 4b and 4c.

FIG. 8 is a partial sectional view of the mold component of FIG. 4b taken along line 8-8 of FIG. 4b.

FIG. 9 is a partial sectional view of the mold component of FIG. 4c taken along line 9-9 of FIG. 4c.

### DETAILED DESCRIPTION OF THE PREFERRED EMBODIMENT

The invention shall be illustrated with reference to a preferred embodiment which shall be described in detail. It is not the intention of applicant that the invention be limited to the preferred embodiment, but rather that the invention shall be defined by the appended claims and all equivalents thereof.

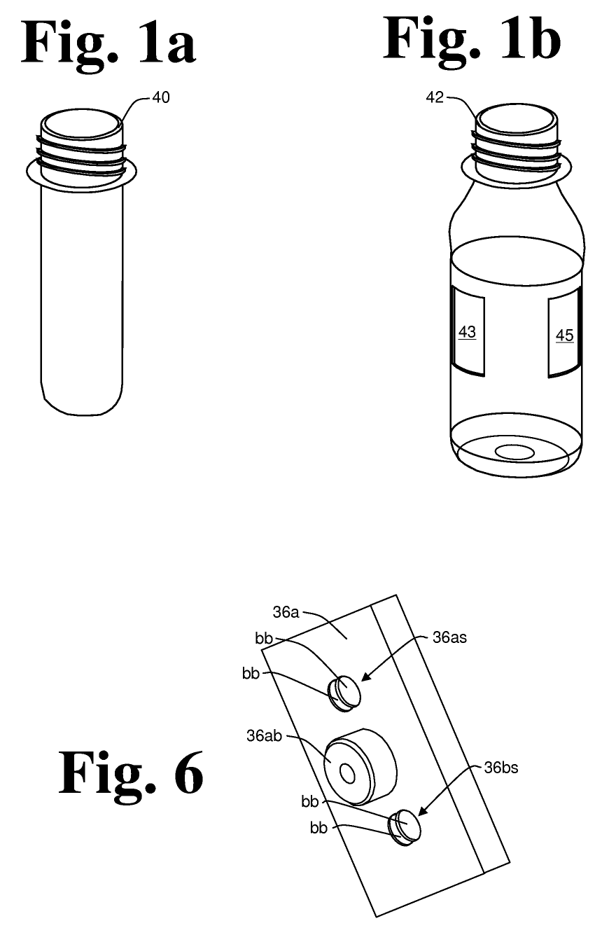

A two-stage blow molding process expands a preformed parison, typically including a completed neck finish, to produce a finished container, a preformed parison 40 shown in FIG. 1a, and a container 42 blow molded therefrom shown in FIG. 1b. Preformed parison 40 is typically produced by injection molding. In preparation for blow molding, the material of preformed parison 40 is typically conditioned (heated) to be made deformable. A mold assembly is closed around the conditioned, preformed parison and blow molding commences with closure of the mold assembly. During blow molding, pressurization of preformed parison 40 is advantageously accompanied by mechanical stretching along the length of preformed parison 40 to produce container 42. Following expansion, the material of container 42 is conditioned (cooled) to become sufficiently rigid for removal from the mold assembly. As shown in FIG. 1b, container 42 comprises side panels such as side panels 43 and 45 that may comprise surface decoration such as a product logo. Such side panels may be recessed inwardly from the surface of the container or may project outwardly from the surface of the container. The relative depth of such side panels as compared to the surrounding container surface affects both appearance and volume of the container. Hence, containers differing in appearance and volume but otherwise having the same dimensions may be blow molded from mold assemblies defining differing relative depths of such panels.

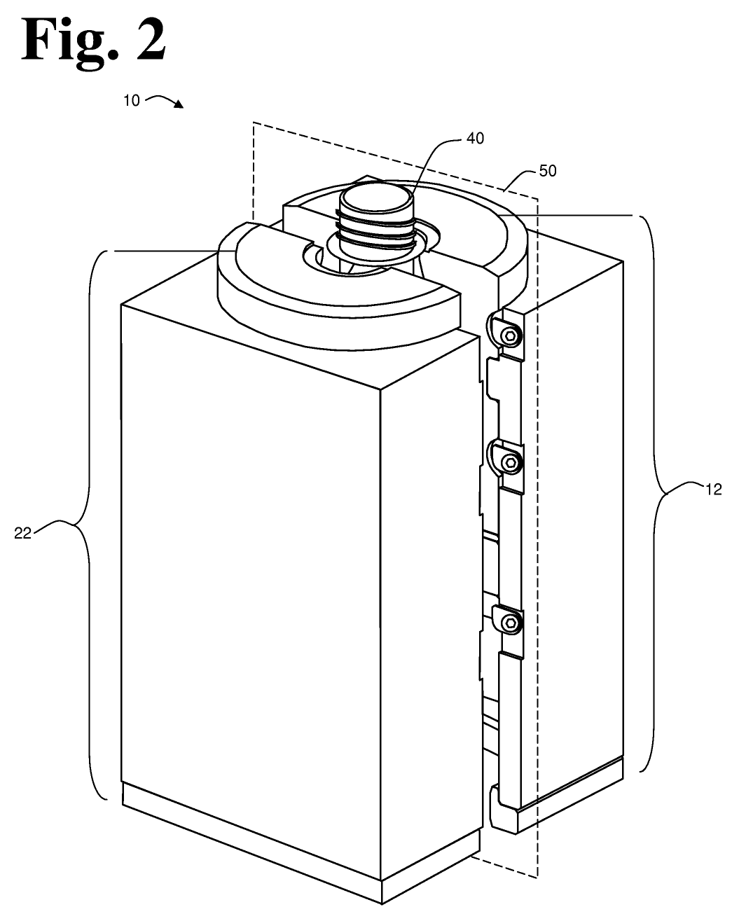

Referring to FIG. 2, mold assembly 10 comprises mating mold components 12 and 22 each referred to herein as a “mold half”. Each of mold components 12 and 22 is carried by a member of a molding machine press (not shown) for translating the mold components between open and closed positions relative to each other (the relative position depicted in FIG. 2 is between the fully open and fully closed positions). In the open position, mold components 12 and 22 are separated permitting admission of a parison such as parison 40 there between and removal of a molded article upon completion of a molding operation. In the closed position, mating faces of mold components 12 and 22 abut at parting plane 50, the abutting faces of mold components 12 and 22 having molding surfaces thereon defining a cavity. Parison 40 is tubular, and as shown in FIG. 2, comprises a completed neck finish as is known in two-stage blow molding. While the invention is suitable for use with single-stage blow molding, the preferred embodiment will be described with reference to a two-stage blow molding process. Parison 40 is preformed with an open mouth and a closed end (not shown) disposed opposite the open mouth. The wall thickness, diameter and length of parison 40 are chosen in accordance with properties of the material from which it is produced and the extent of expansion to be effected both axially and radially during blow molding. With the molds closed surrounding the parison, the parison is pressurized to expand the parison material to abut the molding surfaces of the cavity, and in some instances, mechanically stretched longitudinally by introduction of a stretch rod or the like through the parison mouth as is known. Containers produced using mold assembly 10 advantageously comprise neck portions having surface features formed thereon such as the threads shown in FIG. 2 for engaging a container closure.

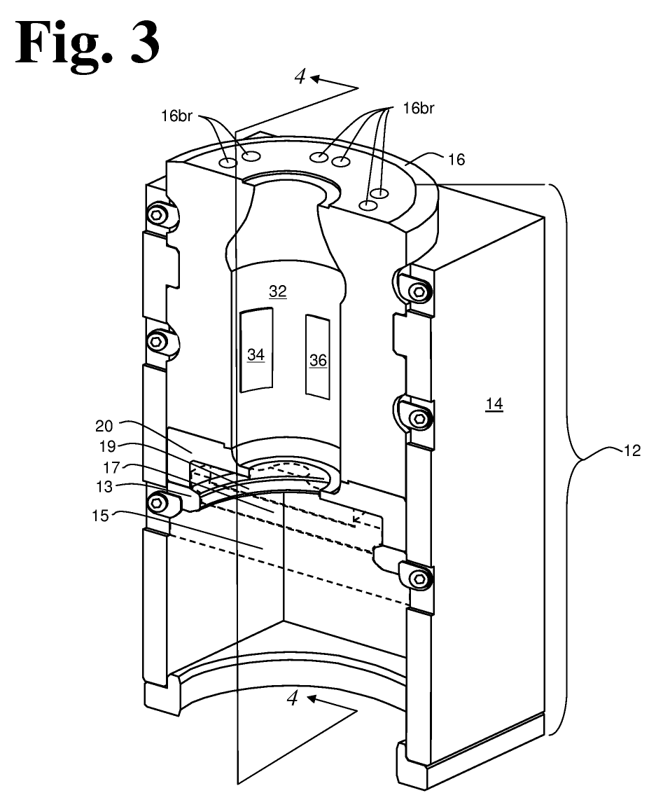

Referring to FIG. 3, mold component 12 comprises shell 14 supporting mold components 16 and 20, referred to herein as “mold inserts”. Mold inserts 16 and 20 comprise molding surfaces 32 of the cavity defining the body of the container to be blow molded. A mold base 19 (shown in phantom (dashed line) in FIG. 3) comprises molding surfaces defining at least a portion of the closed end of the container and is mounted to mold insert 20 by base support 17 and support retainer 15 (both shown in phantom (dashed line) in FIG. 3). Advantageously, concavity of the closed end of container 42 is provided by the molding surfaces of mold base 19. Base support 17 and support retainer 15 are fastened together by bolts or the like (not shown). The periphery of the thus assembled base support 17 and support retainer 15 engage the projection of locating ridge plate 13. In addition to mold inserts 16 and 20, molding surfaces 32 comprise portions defined by replaceable inserts 34 and 36 forming side panels in the body portion of container 42.

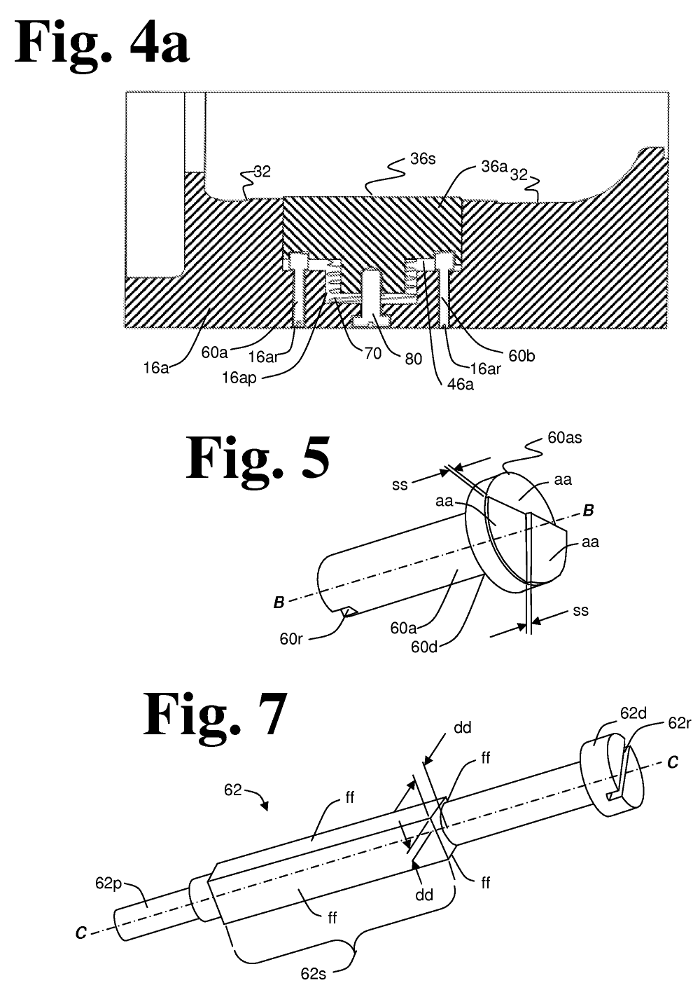

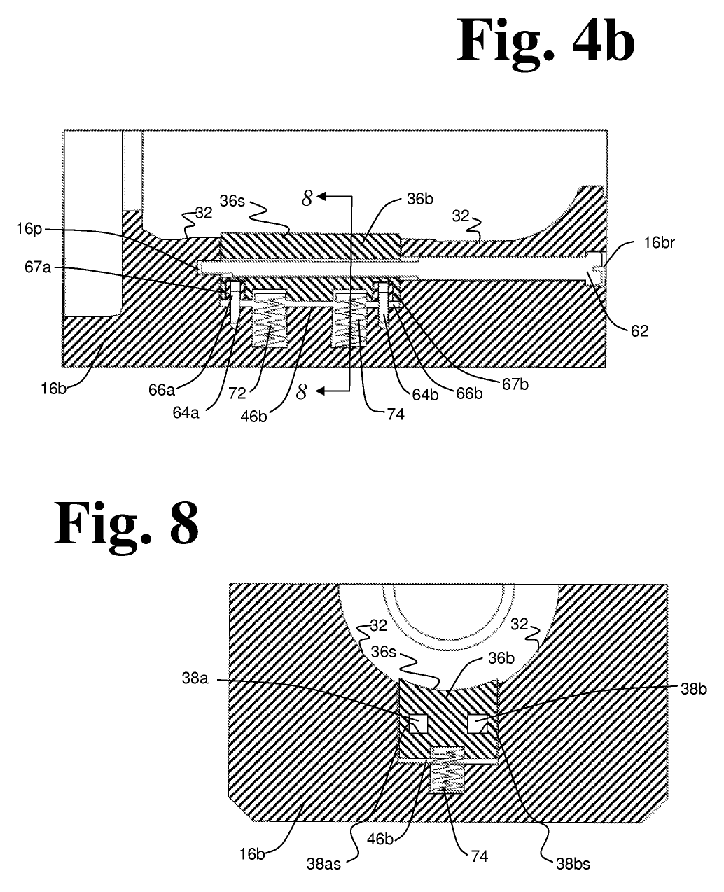

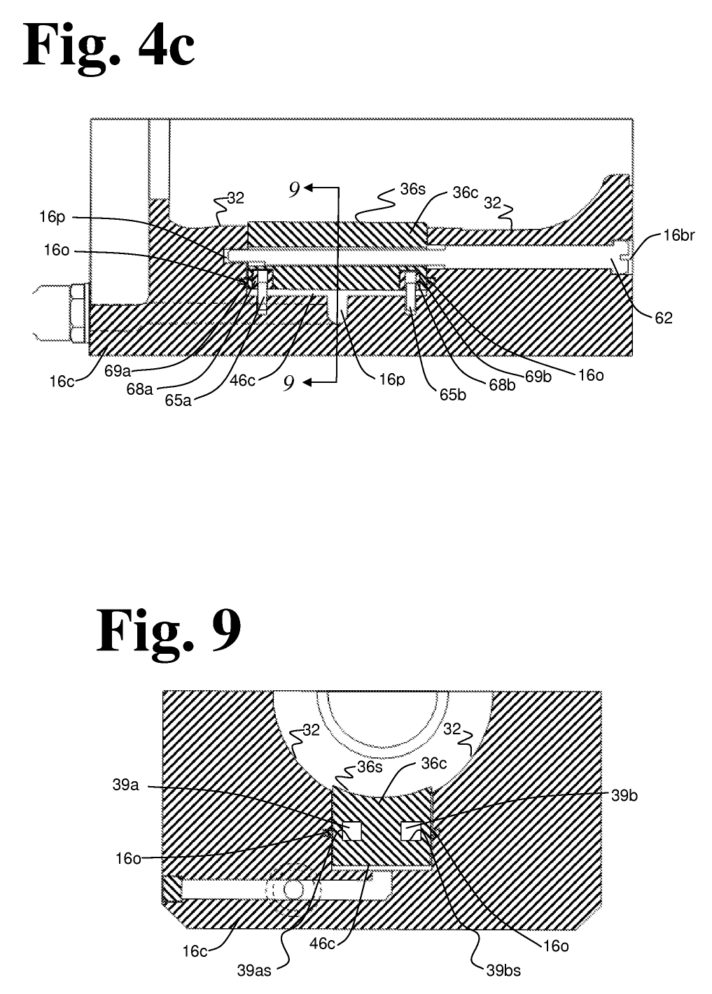

Each of FIGS. 4a, 4b and 4c depict partial cross sections of alternative constructions to achieve incremental adjustment of depth of a replaceable panel insert such as replaceable panel insert 36 of FIG. 3. In FIG. 4a panel insert 36a is shown within recess 46a of a mold component 16a corresponding to mold insert 16 of FIG. 3; in FIG. 4b panel insert 36b is shown within recess 46b of a mold component 16b corresponding to mold insert 16 of FIG. 3; and in FIG. 4c panel insert 36c is shown within recess 46c of a mold component 16c corresponding to mold insert 16 of FIG. 3. Elevation of molding surfaces 36s of replaceable panel inserts 36a, 36b, and 36c relative to the molding surfaces 32 surrounding recesses 46a, 46b, and 46c, respectively, determines the relative depth or projection of a side panel such as side panels 43 and 45 of container 42. In accordance with the invention, the relative depth of each of inserts 36a, 36b, and 36c is adjustable in predetermined increments while each of inserts 36a, 36b and 36c remain attached to mold insert 16.

Referring to FIGS. 4a, 5 and 6, replaceable insert 36a is retained in the recess 46a of mold component 16a by fastener 80. Biasing means, such as spring 70, are interposed between replaceable insert 36a and mold component 16a to apply a force to replaceable insert 36a tending to separate replaceable insert 36a from mold component 16a. As shown, replaceable insert 36a includes a projecting boss 36ab that is surrounded by spring 70 and mold component 16a comprises pocket 16ap to receive the lower end of spring 70. The combination of projecting boss 36ab and pocket 16ap prevent lateral movement of spring 70 that could otherwise result from compression and expansion of spring 70. Indexable posts 60a and 60b comprise seating surfaces such as 60 as (FIG. 5) and insert 36a comprises support surfaces 36 as and 36bs. Depth of replaceable insert 36a in recess 46a is determined by abutment of features of support surfaces 36 as and 36bs with features of seating surfaces of indexable posts 60a and 60b.

Referring to FIGS. 5 and 6, indexable post 60a comprises stepped seating surface 60 as on one end thereof and tool engageable features 60r on the opposite end thereof. The tool engageable feature 60r is advantageously a slot for engagement with a bladed tool such as a screwdriver for rotating indexable post 60a. Tool engageable feature 60r is accessible from an opening 16ar in mold component 16 that is exposed with the mold component removed from a shell 14 (FIG. 4a). Features of seating surface 60 as establishing depth of insert 36a in recess 46a comprise steps “aa”, each step aa being planar, transverse to the longitudinal centerline B-B of the indexable post and having a top surface a predetermined distance from shoulder 60d establishing an incremental step height “ss”. The number and arrangement of steps “aa” determines, at least in part, the number of increments of adjustment of depth achievable by particular indexable posts. In FIG. 5, indexable post 60a is shown having three steps “aa” comprising seating surface 60 as. As seen in FIG. 6, mating support surfaces 36 as and 36bs are located on the side of replaceable insert 36a facing seating surfaces 60 as and each comprise two steps “bb”. The step “bb” nearest the underside surface of replaceable insert 36a is abutted with a facing one of steps “aa” of the opposed indexable post. To achieve increments of adjustment in addition to those determined by steps “aa”, support surfaces 36 as and 36bs could comprise more than one step “bb” to be abutted with a facing step “aa”—the depth and arrangement of such steps “bb” being constrained by the arrangement and projection of steps “aa” so as to effect abutment of only a single step “bb” with a single step “aa”. With support surfaces 36 as and 36bs abutting seating surfaces of indexable posts 60a and 60b, respectively, depth of replaceable insert 36a in recess 46a is established by abutment of particular steps “aa” and “bb”. Fastener 80 clamps one of steps “bb” of each of support surfaces 36 as and 36bs of replaceable insert 36a into abutment with one of steps “aa” of seating surfaces of each of indexable posts 60a and 60b.

Adjustment of depth of replaceable panel insert 36a in recess 46a is effected by relieving the clamping force exerted by fastener 80 to allow separation of support surfaces such as support surfaces 60 as (FIG. 5) from seating surfaces 36 as and 36bs respectively, rotating each of indexable posts 60a and 60b to align selected features of the seating surfaces with mating features of support surfaces 36 as and 36bs, respectively, and restoring the clamping force of fastener 80 to bring the aligned features of the seating surfaces into abutting contact with the mating features of support surfaces 36 as and 36bs.

Referring to FIGS. 4b, 7 and 8, replaceable insert 36b is retained in recess 46b of mold component 16b by indexable rods such as indexable rod 62 (FIG. 7) passing through holes 38a and 38b. Resilient biasing means such as springs 72 and 74 apply a force on replaceable insert 36b to maintain abutment of support surfaces of through holes 38a and 38b with the facing flat ff of seating surface 62s of indexable rod 62. Advantageously, replaceable insert 36b includes pockets for receiving the upper ends of springs 72 and 74 and mold component 16b includes pockets for receiving the lower ends of springs 72 and 74 thereby preventing lateral displacement of the springs with compression and extension thereof. To further advantage, locating posts, such as locating posts 64a and 64b project from mold component 16b into the facing surface of panel insert 36b. Locating posts 64a and 64b maintain lateral alignment of replaceable insert within recess 46b so as to prevent binding during movement of panel insert 36b therein. To particular advantage in this regard, bushings 66a and 66b are positioned within recesses 67a and 67b, respectively. The bushings 66a and 66b permit sliding contact between replaceable insert 36b and locating posts 64a and 64b.

Referring to FIGS. 7 and 8 depth adjusting features of seating surfaces 62s of indexable rods 62 comprise longitudinal flat surfaces “ff” spaced by differing offsets “dd” from the axial centerline C-C. In FIG. 7, four flat surfaces “ff” are shown, the number and arrangement of flat surfaces “ff” determines the range and increments of adjustment of depth of replaceable insert 36b in recess 46b. Pilot end 62p of indexable rod 62 is cylindrical and concentric with axial centerline C-C. Drive end 62d comprises a tool engageable feature 62r. Pilot end 62p is received in a pilot bore 16p (FIGS. 4b and 4c) in mold component 16. Tool engageable feature 62r is advantageously a slot engageable by a bladed screwdriver to permit rotation of indexable rod 62 about its axial centerline. The tool engageable feature 62r is advantageously accessible from an opening 16br in mold component 16 that is exposed with the mold assembly 10 mounted in a machine (FIGS. 4b, 4c and 3). Through holes 38a and 38b comprise flat support surfaces 38 as and 38bs (FIG. 8—for clarity, indexable rods 62 are not shown in the cross section of FIG. 8). As shown in FIG. 8, each of through holes 38a and 38b have a square cross section. However, any cross section of through holes 38a and 38b may be used provided each of support surfaces 38 as and 38bs is predominantly flat to permit surface contact when abutted with a flat “ff” of indexable rod 62.

Adjustment of depth of replaceable panel insert 36b is effected by applying a force to panel insert 36b to compress springs 72 and 74 to relieve the force abutting support surfaces of through holes 38a and 38b with the facing seating surface 62s of the indexable rods 62, rotating each of indexable rods 62 to change the particular feature of seating surface 62s facing support surfaces of through holes 38a and 38b and relieving the force applied to panel insert 36b to allow expansion of springs 72 and 74. The force exerted by springs 72 and 74 may be selected to be overcome manually, but such arrangements are not suitable for use where the force exerted on panel insert 36b during expansion of parison 40 is sufficient to compress springs 72 and 74.

Referring to FIGS. 4c, 7 and 9, replaceable insert 36c is retained in recess 46c of mold component 16c by indexable rods such as indexable rod 62 (FIG. 7) passing through holes 39a and 39b. A force acting on replaceable insert 36c is exerted by a pressurized fluid (pneumatic or hydraulic) to maintain abutment of support surfaces of replaceable insert 36c with facing seating surfaces of indexable rod 62. Passage 16p admits pressurized fluid to the underside of replaceable insert 36c. Sealing means 16o are interposed between the periphery of replaceable insert 36c and the sidewalls of recess 46c to close a variable volume bounded by walls of the recess and by the insert and to prevent leakage of pressurized fluid admitted through passage 16p from that variable volume. Advantageously, locating posts, such as locating posts 65a and 65b project from mold component 16c into the facing surface of replaceable insert 36c. Locating posts 65a and 65b maintain lateral alignment of replaceable insert 36c within recess 46c so as to prevent binding during displacement of replaceable insert 36c therein. To particular advantage in this regard, bushings 68a and 68b are positioned within recesses 69a and 69b. The bushings 68a and 68b permit sliding contact between replaceable insert 36c and locating posts 65a and 65b.

Referring to FIGS. 7 and 9, the number and arrangement of flats “ff” comprising seating surfaces 62s of indexable rod 62 determine the range and increments of adjustment of depth of replaceable insert 36c in recess 46c. As seen in FIG. 9, through holes 39a and 39b comprise flat support surfaces 39 as and 39bs (FIG. 9—for clarity, indexable rods 62 are not shown in the cross section of FIG. 9). As shown in FIG. 9, each of through holes 39a and 39b have a square cross section. However, any cross section of through holes 39a and 39b may be used provided each of support surfaces 39 as and 39bs is predominantly flat to permit surface contact when abutted with a flat “ff” of indexable rod 62.

To adjust depth of panel insert 36c, fluid pressure is reduced relieving the force exerted on replaceable insert 36c, each indexable rod 62 is rotated to change the particular flat “ff” of seating surface 62s facing support surface 39 as and 39bs and fluid pressure is restored to its operational level. The force exerted on panel insert 36c by the pressurized fluid can be as great as or greater than the force exerted on panel insert 36c during expansion of parison 40 so that panel insert 36c is not displaced by forces of expansion of the parison. Hence, the arrangement of FIGS. 4c, 7 and 9 is suitable for a wide range of blow molding processes.

While the invention has been illustrated and described with reference to the preferred embodiments of the drawing figures, it is not intended that the scope of the invention be defined by the preferred embodiments. In particular, it is contemplated that the invention be applied to apparatus for so called “single stage” blow molding wherein a parison is extruded, the extruded parison is pinched closed on one end thereof and an article is blow molded by expansion of the thus closed parison. Further, while the preferred embodiments illustrate the panel inserts as comprising mold inserts of a mold assembly, it is contemplated that panel inserts in accordance with the invention could comprise mold components that are configured for being mounted in a machine press other than in mold assemblies comprising shells such as shell 14 as shown and described. Finally, while the panel inserts of the invention are illustrated as applied to mold components for production of containers, panel inserts in accordance with the invention may comprise mold components for blow molding any article wherein it is desirable to effect variations in the depth of a molded panel to produce differing articles from a single mold assembly.

What is claimed is:

1. An apparatus for blow molding comprising first and second mating mold components, molding surfaces of each mold component being open to the mating face thereof, at least one panel insert comprising the molding surfaces of at least one mold component, each panel insert being received in a recess of the associated mold component and the depth of at least one panel insert within the associated recess being adjustable in predetermined increments while the panel insert is retained in the recess of the mold component.

2. The apparatus according to claim 1 wherein the depth of the at least one panel insert of adjustable depth relative to the recess is determined by abutment of stepped seating surfaces comprising at least one indexable post and stepped support surfaces comprising the insert, steps of each of the seating surfaces and support surfaces being brought into abutting contact by retaining means retaining the panel insert in the recess of the mold component.

3. The apparatus according to claim 2 wherein the stepped seating surfaces comprise at least two steps differentiated by at least one predetermined step height and the stepped support surfaces comprise at least two steps differentiated so that only a single step of each seating surface will abut a facing step of a support surface.

4. The apparatus according to claim 2 wherein the retaining means is effective to apply a retaining force to retain the seating surfaces and support surfaces in abutment and the retaining means comprise a biasing means for applying a force to the panel insert to effect separation of seating surfaces and support surfaces when the retaining force is relieved.

5. The apparatus according to claim 4 wherein the means for applying a retaining force comprises a threaded fastener the threaded end of which passes through an opening in the mold component and engages a thread in the panel insert and the biasing means comprises a biasing spring interposed between the panel insert and mold component and surrounding the threaded fastener.

6. The apparatus according to claim 1 wherein the depth of the at least one panel insert of adjustable depth relative to the recess is determined by abutment of a seating surface comprising at least one indexable rod and a support surface comprising the insert, the seating surface of each indexable rod comprising plural flats for determining the depth of the panel insert within the recess of the mold component, at least two such flats being spaced from the axial centerline of the rod by differing predetermined offsets, contact of the support surface with one flat of the seating surface establishing a depth of the panel insert different from the depth of the panel insert established by abutting contact with at least one other flat of the seating surface and the apparatus further comprises means for biasing the support surface into abutting contact with the seating surface.

7. The apparatus of claim 6 wherein the means for biasing the support surface into abutting contact with the seating surface comprises at least one resilient member interposed between the insert and the mold component, the resilient member being compressed irrespective of the orientation of the indexable rod so as to exert a force on the panel insert to abut the support surface with the seating surface.

8. The apparatus of claim 6 wherein the means for biasing the support surface into abutting contact with the seating surface comprises a passage open to a side of the panel insert received within the recess for admitting a pressurized fluid between the panel insert and the mold component, the pressurized fluid applying a force to the panel insert to abut the support surface with the seating surface.

9. The apparatus according to claim 8 further comprising sealing means interposed between the periphery of the panel insert and the sidewalls of the recess to close a variable volume bounded by the walls of the recess and by the insert and to prevent leakage of pressurized fluid admitted through the passage from the variable volume.

10. An apparatus for blow molding comprising first and second mating mold components, molding surfaces of each mold component being open to the mating face thereof, at least one panel insert comprising the molding surfaces of at least one mold component, each panel insert being received in a recess of the associated mold component and the depth of at least one panel insert within the associated recess being adjustable in predetermined increments while the panel insert is retained in the recess of the mold component and the apparatus comprises at least one indexable post comprising stepped seating surfaces, stepped support surfaces comprising the insert and steps of each of the seating surfaces and support surfaces are brought into abutting contact by retaining means retaining the panel insert in the recess of the mold component.

11. The apparatus according to claim 10 wherein the stepped seating surfaces comprise at least two steps differentiated by at least one predetermined step height and the stepped support surfaces comprise at least two steps differentiated so that only a single step of each seating surface will abut a facing step of a support surface.

12. The apparatus according to claim 10 wherein the retaining means is effective to apply a retaining force to retain the seating surfaces and support surfaces in abutment and the retaining means comprise a biasing means for applying a force to the panel insert to effect separation of seating surfaces and support surfaces when the retaining force is relieved.

13. The apparatus according to claim 12 wherein the means for applying a retaining force comprises a threaded fastener the threaded end of which passes through an opening in the mold component and engages a thread in the panel insert and the biasing means comprises a biasing spring interposed between the panel insert and mold component and surrounding the threaded fastener.

14. An apparatus for blow molding comprising first and second mating mold components, molding surfaces of each mold component being open to the mating face thereof, at least one panel insert comprising the molding surfaces of at least one mold component, each panel insert being received in a recess of the associated mold component and the depth of at least one panel insert within the associated recess being adjustable in predetermined increments while the panel insert is retained in the recess of the mold component and the apparatus comprises at least one indexable rod comprising a seating surface, a support surface comprising the insert and the seating surface of each indexable rod comprises plural flats for determining the depth of the panel insert within the recess of the mold component, at least two such flats being spaced from the axial centerline of the rod by differing predetermined offsets, contact of the support surface with one flat of the seating surface establishing a depth of the panel insert different from the depth of the panel insert established by abutting contact with at least one other flat of the seating surface and the apparatus further comprises means for biasing the support surface into abutting contact with the seating surface.

15. The apparatus according to claim 14 wherein the means for biasing the support surface into abutting contact with the seating surface comprises at least one resilient member interposed between the insert and the mold component, the resilient member being compressed irrespective of the orientation of the indexable rod so as to exert a force on the panel insert to abut the support surface with the seating surface.

16. The apparatus according to claim 14 wherein the means for biasing the support surface into abutting contact with the seating surface comprises a passage open to a side of the panel insert received within the recess for admitting a pressurized fluid between the panel insert and the mold component, the pressurized fluid applying a force to the panel insert to abut the support surface with the seating surface.

17. The apparatus according to claim 16 further comprising sealing means interposed between the periphery of the panel insert and the sidewalls of the recess to close a variable volume bounded by the walls of the recess and by the insert and to prevent leakage of pressurized fluid admitted through the passage from the variable volume.
